(19) United States
(12) Patent Application Publication
(10) Pub. No.: US 2020/0370851 A1
(43) Pub. Date: Nov. 26, 2020

(54) SMART TRIGGERING DEVICE FOR A FIREARM

(71) Applicant: Manouch Shahbaz, Houston, TX (US)

(72) Inventor: Manouch Shahbaz, Houston, TX (US)

(21) Appl. No.: 16/874,430

(22) Filed: May 14, 2020

Related U.S. Application Data
(60) Provisional application No. 62/847,674, filed on May 14, 2019.

(51) Int. Cl. F41A 17/06; G06K 9/00

(52) U.S. Cl. CPC F41A 17/066; G06K 9/00892

(57) ABSTRACT

The present invention provides a smart triggering device for restricting unauthorized access to a firearm. The smart triggering device is capable of configuring with a trigger of the firearm. The access is provided by activating the trigger of the firearm based on the biometric input of a user. An electromechanical stopper of the smart triggering device activates the trigger based on the biometric input.

### CROSS-REFERENCE TO RELATED APPLICATION

This application claims the benefit of U.S. Provisional Patent Application No. 62/847,674, filed Jul. 1, 2018, which is incorporated by reference herein in its entirety.

### FIELD OF INVENTION

The present invention relates to a smart triggering device configured with a firearm. More specifically, the present invention provides a smart triggering device which is responsive to a biometric input for providing authorized access to the firearm.

### BACKGROUND OF THE INVENTION

Authorized firearm access is a major concern today. Communities with firearm access including policeman, bodyguards, licensed celebrities, etc, fall short of measures to prevent unauthorized access to their firearm. Gun violence occurring today is a result due to frequent misuse of firearms by unauthorized individuals such as kids, naïve user, untrained professional etc. Accordingly, there is a need of an authorized firearm access that renders the firearm use to anyone but an authorized user.

Traditional locking systems or safe boxes for storing and locking firearms or handguns are known in the art. The sole purpose is to prevent unauthorized access or use by any untrained professional, including kids etc. These locking systems are useful in limiting access to the handguns in private, commercial or public use. For private use, it is more desirable to prevent unauthorized access or use of handguns by children, intruders, or other unauthorized individuals. While in commercial use, these systems are utilized for preventing unauthorized access or use of handguns during theft or inadvertent misplacement.

Conventional systems in use are basic mechanical locks that comprise mechanical components along with a key, a combination dial or similar means. Such mechanical locks require allot of time to manipulate key or enter suitable combination. In case of an alert, these conventional types of lock are a big failure. Moreover, the mechanical components are subject to wear and tear. For instance, key and its combination can be accessed by unauthorized individuals by stealing. These drawbacks make the use of mechanical locks undesirable. To overcome the failure of mechanical locks, electrical locks are required.

One such electrical lock is described in U.S. Pat. No. 5,713,149 patent assigned to Speed Release Lock Co. The patent discloses a system that utilizes an electronic code-entry for electromechanical locking the firearm. However, the disclosed electrical locks provide same drawbacks as like the mechanical systems where codes can be accessed and used by unauthorized personnel or entry. Additionally, these systems allow access which is undesirably delayed due to the time taken to enter a code. Access may be altogether prevented when a user cannot memorize the access code. Additionally, key and combination can be stolen by any unauthorized individual too. Hence, these systems are too insecure for users.

Another U.S. Patent Application No. 20080289237 assigned to Dov Pikielny discloses a firearm including a trigger-actuated firing mechanism. The device selectively prevents and permits the firing mechanism to be actuated and triggered. Additionally, the patent discloses an authentication device that works in conjunction with a safety device for recognizing an authorized shooter. Specifically, the system includes a recognition device such as a fingerprint or palm print recognition device capable of identifying the shooter's hand. The recognition device is configured with a handle of the firearm. Further, the recognition device permits unlocking the weapon only for an authorized user. Though the invention overcomes with the previous drawbacks there is still a need for a robust and comprehensive firearm authentication system that allows precise and quick access to the user, without any unauthorized access.

In other words, there is a need for a firearm authentication device that shall include a firing mechanism that is easy to block or provide access to the user upon recognition based on authentication. Additionally, the system shall provide quick access to the firearm in alarming situation.

It is apparent now that numerous methods and systems are developed in the prior art that are adequate for various purposes. Furthermore, even though these inventions may be suitable for the specific purposes to which they address, accordingly, they would not be suitable for the purposes of the present invention as heretofore described. Thus, there is a need for a system for providing authorized access to the firearm.

### SUMMARY OF THE INVENTION

The present invention provides system and method for restricting an unauthorized access by a user to the firearm, including, but not limited to handguns, pistols, revolvers, rifles or the like . More specifically, the present invention provides a smart triggering device configured with the firearm. The smart triggering device includes a biometric recognition surface configured with a trigger of the firearm. The biometric recognition surface is capable of receiving a biometric input from the user. The smart triggering device further includes an electronic unit connected via a high gauge wire to the biometric recognition surface. The electronic unit includes a data memory chip for storing records of the user and a biometric recognition chip for matching the biometric input with the records of the user for verification purpose. The electronic unit is further connected to an electromagnetic stopper via the high gauge wire. The electromagnetic stopper is connected to the electronic unit and the biometric recognition surface using the high gauge wires. Furthermore, the electromagnetic stopper is capable of mechanically coupling with a hammer rod assembly of the firearm. The hammer rod assembly includes a safety rod and a firing hammer connected via a spring. The electromagnetic stopper conditionally retrieves to engage with the safety rod for blocking and unblocking the trigger of the firearm. The conditional retrieving is based the biometric input received from the user.

A primary objective of the present invention is to provide a smart triggering device that activates the trigger of the firearm in particular conditions including, but not limited to dropping, dislocating of the firearm during tussle or altercation. Specifically, the invention provides security and safety for the firearm owners, including policeman and law enforcement individuals.

Another objective of the present invention is to provide a smart triggering device which can be programmed to allow use of the firearm by a group of authorized users only, and hence preventing any misuse by unauthorized users.

A further objective of the present invention is to provide a smart triggering device that verifies the identity of the user within microseconds, thereby providing quick access to the firearm during alarming conditions.

It is an objective of the present invention to provide a smart triggering device which detects the biometric input of a user on the biometric recognition surface configured with the trigger assembly of the firearm. Furthermore, the system saves time for the firearm to fire during the emergency situation.

In one embodiment of the present invention, the smart triggering includes the fingerprint recognition surface placed on the trigger of the firearm. In an alternative embodiment of the present invention, the biometric input is of a fingerprint of the user. In yet another embodiment of the present invention, the biometric input is of an index finger or a shooting finger of the user. In an alternative embodiment of the present invention, the smart triggering device is capable of being augmented with an additional biometric input selected from a group including retina, voice, facial, or an iris and the like, along with the fingerprint of the user. In one embodiment, the biometric recognition surface is a configured with a biometric sensor placed on the trigger for receiving the biometric input.

In one embodiment of the present invention, the electronic unit includes a data memory chip and a biometric recognition chip connected to the data memory chip via the gauge wire. The biometric recognition chip compares the biometric input with record of the user. The record of the user is stored in the data memory chip of the electronic unit. The biometric recognition chip and the data memory chips are microchips.

In another embodiment of the present invention, the electronic unit further includes a battery connected with the data memory chip and the biometric recognition chip via the high gauge wire. The battery provides voltage to the smart triggering device, In one embodiment of the present invention, the battery is a 5 Volt Lithium DC Battery. The electronic unit further includes a USB port for charging the battery. The USB Port is also used for the data retrieval purposes. The USB Port is used to retract record of the user including biometric information, firearm operational details such as but not limited to firing time, date etc.

In yet another embodiment of the present invention, the electromagnetic stopper includes a flat head shaft and a key stopper connected via a high gauge linear spring. The electromagnetic stopper is housed within a positively protruding fine threaded housing. The flat head shaft of the electromagnetic stopper retrieves to unblock the hammer rod assembly, thereby allowing the user to access the firearm. The positive protruding fine threaded housing is housed in a negative recessed threaded housing on a hand grip of the firearm.

In one another embodiment of the present invention, the hammer rod assembly includes a safety rod and a firing hammer connected via a spring. The flat head shaft of the electromagnetic stopper electromechanically engages with the safety rod to unlock the trigger to be pulled back for striking a bullet to be fired from the firearm.

In alternative embodiment, the present invention provides a method for preventing unauthorized access to a firearm. The method includes receiving a biometric input through a biometric recognition surface coupled with a trigger of the firearm. The method further includes comparison of the biometric input with the record of user stored in an electronic unit. Based on the matching of the biometric input with the record of the user, a signal through the electronic unit is generated. The signal generated by the electronic unit is passed on to an electromagnetic stopper. Upon receiving the signal, the electromagnetic stopper retrieves to unblock a hammer rod assembly. The hammer rod assembly disengages for unlocking a trigger of firearm, thereby allowing the user to access the firearm.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a smart triggering device configured with a firearm in accordance with the present invention;

FIG. 2 illustrates the smart triggering device in accordance with the present invention;

FIG. 3 illustrates a biometric recognition surface of the smart triggering device in accordance with the present invention;

FIG. 4 illustrates an electronic unit of the smart triggering device in accordance with the present invention;

FIG. 5 illustrates an electromagnetic stopper of the smart triggering in accordance with the present invention; and

FIG. 6 illustrates a method of triggering the firearm with the smart triggering device

### DETAILED DESCRIPTION OF THE INVENTION

The present invention is directed to a system and a method for preventing unauthorized access to the conventional firearms, such as handguns, pistols and revolvers. The system utilizes a control mechanism that is responsive to a biometric input of a user. Specifically, the present invention provides a smart triggering device that provides ultimate security and safety for gun owners such as, but not limited to, law enforcement individuals, policeman and licensed practitioners. The present invention allows integration of the firearm with the smart triggering device in order to ensure safety of the user. More particularly, the smart triggering device allows can programmed with the details of the gun owner, one or more other user that are authorized by the gun owner.

Specifically, the present invention provides a smart triggering device configured with the firearm. The smart triggering device includes a biometric recognition surface configured with a trigger of the firearm. The biometric recognition surface is capable of receiving a biometric input from the user. The smart triggering device further includes an electronic unit connected via a high gauge wire to the biometric recognition surface. The electronic unit includes a data memory chip for storing records of the user and a biometric recognition chip for matching the biometric input with the records of the user for verification purpose. The electronic unit is further connected to an electromagnetic stopper via the high gauge wire. The electromagnetic stopper is connected to the electronic unit and the biometric recognition surface using the high gauge wires. Furthermore, the electromagnetic stopper is capable of mechanically coupling with a hammer rod assembly of the firearm. The hammer rod assembly includes a safety rod and a firing hammer connected via a spring. The electromagnetic stopper conditionally retrieves to engage with the safety rod for blocking and unblocking the trigger of the firearm. The conditional retrieving is based the biometric input received from the user.

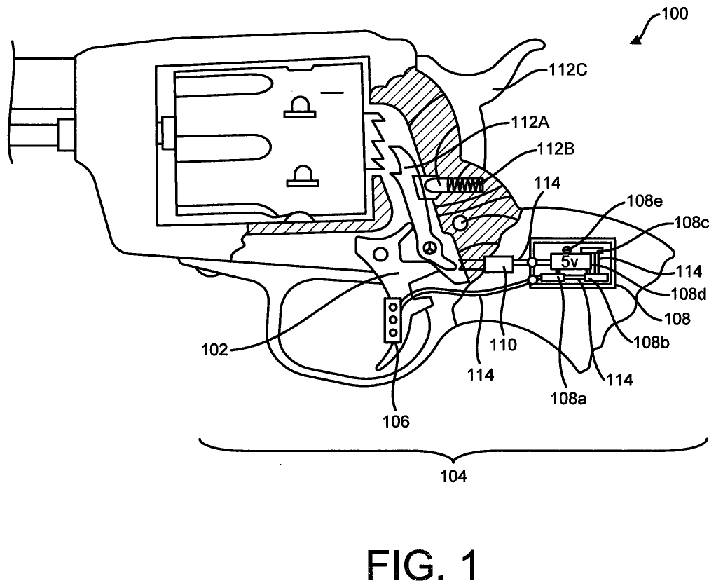

In accordance with FIG. 1, the firearm (100) including a trigger (102) is fitted with a smart triggering device (104). The smart triggering device (104), when appropriately programmed, discriminates between authorized users and unauthorized users so as prevent unauthorized users from utilizing the firearm. The smart triggering device (104) includes a biometric recognition surface (106), an electronic unit (108), an electromagnetic stopper (110) and a hammer rod assembly (112). The biometric recognition surface (106), the electronic unit (108) and the electromagnetic stopper (110) are connected to each other via a high gauge wire (114).

The biometric recognition surface (106) is secured on a trigger (102) of the firearm (100) which is capable of accepting a biometric input of would-be users of the firearm (100). The biometric recognition surface (106) is connected to the electronic unit (108) of the smart triggering device (104) by the high gauge wire (114). The biometric recognition unit (106) receives the biometric input and then the biometric input is further processed in the electronic unit (108).

The electronic unit (108) includes a data memory chip (108A) which stores a record of a user; and a biometric recognition chip (108B). The biometric recognition chip (108B) compares and matches the received biometric input in the stored records of the user. The biometric recognition chip (108B) verifies authorization of the user, either the gun user is an authorized user or not. The electronic unit (108) generates a signal upon verifying the user to be an authorized user. Based on the comparison step, the electronic unit (108) preferably transmits a signal to an electromagnetic stopper (110) which controls whether the firearm (100) will be unlocked or locked. The electronic unit (108) is connected through the high gauge wire (114) to the electromagnetic stopper (112).

The electronic unit (108) further includes a battery (108C) connected to each of the data memory chip (108A) and the biometric recognition chip (108B). The electronic unit includes a variety of batteries one a USB battery (108C) and a Li-battery (108D) which provides voltage to the smart triggering device (102) for allowing the access to the firearm (100). The electronic unit (108) also includes a USB port (108E) connected to the battery and to the biometric recognition chip (108B).

The electromagnetic stopper (110) includes a flat head shaft (110A); and a key stopper (110B) connected through a high gauge linear spring (110C). The electromagnetic stopper (110) is housed with a positively protruding fine threaded housing which is threaded into a negatively (recessing) threaded housing installed within the handgrip of the firearm. Upon receiving the signal, the electromagnetic stopper (110) selectively engages with a hammer rod assembly (112) of the firearm. The flat head shaft (110A) is spring loaded shaft, which upon receiving signal through the electronic unit (108) retrieves to engage with the hammer rod assembly (112). The size and location of the electromagnetic stopper (110) including flat head shaft (110A) would vary for different firearms depending on types of handgun or other similar firearms.

The hammer rod assembly (112) includes a safety rod (112A) and a firing hammer (112C) connected via a spring (112B). The flat head shaft (110A) engages with the safety rod (112A) to unblock the hammer rod assembly (112). The safety rod (112A) further actuates the firing hammer (112C) via spring (112B) to unlock the trigger (102) of the firearm (100), thereby allowing the authorized user to strike the bullet.

Upon the recognition and verification of the biometric input of the user, the open circuit of the electronic unit (106) will be placed in a closed loop, rendering the spring loaded flat head shaft (110A) of the electromagnetic stopper (110) to retrieve in order to unblock the safety rod (112A) to the firing hammer (112C) while allowing the trigger (102) to be pulled back and make the gun ready to fire.

When the user removes biometric input from the trigger (102) or in a scenario where the firearm is dropped, then the electronic unit's (108) circuit would return back to an open circuit position, spring loaded flat head shaft (110A) of the electromagnetic stopper (110) to retrieve and block the safety rod (112A) to the firing hammer (112C) of the firearm (100). This would prevent the gun from being fired or used by unauthorized persons. Thus, the user is able to access the firearm (100) only till the biometric input is provided to the biometric recognition surface.

In other words, the user is able to render the firearm ready to shoot, after the initial setup by the authorized user or users and once the biometric input is verified by the biometric recognition chip (108B). Furthermore, the user can also choose to bypass the Smart Trigger option by keeping the gun's permanent safety lock on and rendering the Smart Trigger option void.

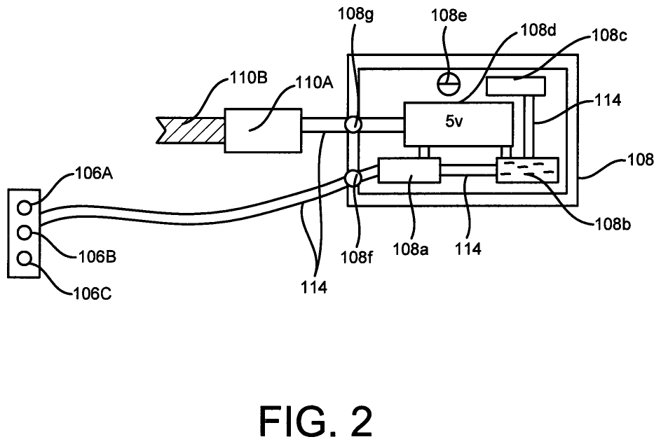

FIG. 2 illustrates the smart triggering device (104). The smart triggering device (104) can be incorporated to firearms (100) of any sort that provides ultimate security and safety for gun owners. Furthermore, additional security features can be integrated in the firearm (100), without the necessity of changing the construction of the firearm.

The smart triggering device (104) comprising a biometric recognition surface (106) configured on the trigger (102) of the firearm (100); an electronic unit (108) embedded within handgrip of the firearm (100); and an electromagnetic stopper (112) connected with the electronic unit (108). The biometric recognition surface (106) includes a plurality of elements that are a receiver (106A), a temporary memory (106B) and a processor (106C). The biometric recognition surface (106) may include any sensor as the receiver (106A) which detects the biometric input of the user. The biometric recognition surface (106) and the electronic unit (108) are connected through the high gauge wire (114). The point where the signal from the biometric surface is received by the electronic unit is an input unit (108f) included in the electronic unit (108) and a processed signal leaves the electronic unit (108) through an output unit (108g) to the electromagnetic stopper (110).

The electromagnetic stopper (110) includes a flat head shaft (110A); and a key stopper (110B) connected through a high gauge linear spring (110C). The electromagnetic stopper (110) is housed with a positively protruding fine threaded housing which is threaded into a negatively (recessing) threaded housing installed within the handgrip of the firearm.

The biometric input is received through the biometric recognition surface (106). The biometric input is further processed by the electronic unit (108). The electronic unit (108), upon receiving the biometric input, compares and matches the user biometric information within the stored data or templates, thereby authenticating the user, if the user is the authorized user. Upon authenticating the user, the electronic unit (108) provides signals to the electromagnetic stopper (110) to retrieve, for unlocking the trigger (102), thereby providing access to the firearm.

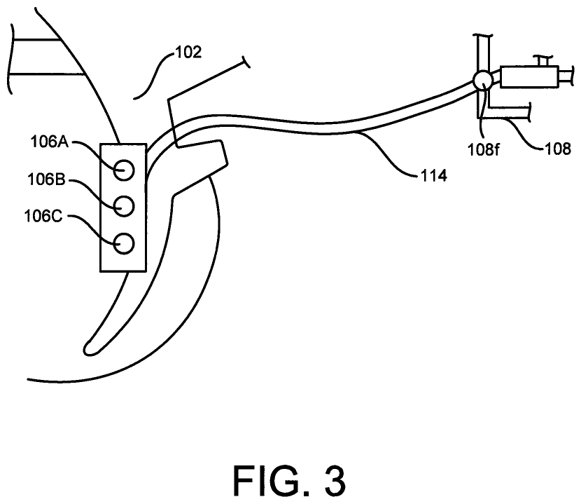

FIG. 3 illustrates the biometric recognition surface (106) disposed on the trigger (102). The biometric recognition surface (106) is secured to the trigger (102) of the firearm (100). The biometric recognition surface (106) includes a plurality of elements that are a receiver (106A), a temporary memory (106B) and a processor (106C). The biometric recognition surface (106) may include any sensor (106A) as the receiver (106A) which detects the biometric input of the user.

In one embodiment, the biometric recognition surface (106) includes a sensor (106A) which detects the biometric input, when the biometric input is provided on the surface. In one alternative embodiment, the biometric recognition surface (106) is fingerprint recognition surface. The fingerprint recognition surface (106) includes a sensor which detects a fingerprint, when a finger is being pressed on the surface. The sensor (106A) is capable of acquiring the biometric print of any portion of the finger including top portion, or middle portion. The finger described herein, can be any finger such as but not limited to index finger or shooting finger, which is being pressed on the fingerprint recognition surface (106), thereby verifies the authorization of the user to use the firearm. When the finger is applied to the fingerprint recognition surface (106), the finger print is recognized and is temporarily stored in the temp memory (106B) and is processed into an encrypted into a signal. The biometric surface transmits the signal to the electronic unit (108) through the high gauge wire (114).

Preferably, however, it is provided that the sensor included in the biometric recognition surface (106) is an electronic sensor, for example as an ultrasonic sensor, a capacitive sensor, a pressure sensitive sensor, an optical sensor, a resistance sensor, a thermal sensor, piezoelectric sensors, or touch sensitive membranes etc.

As an alternative to the fingerprint biometric input or in addition thereto, the biometric recognition surface (106) can be augmented by additional biometric features for identifying the authorized user. The additional biometric input is either of a face, iris, retina, voice etc. Any other sensors or devices suitable to identify an authorized user are within the scope of the invention.

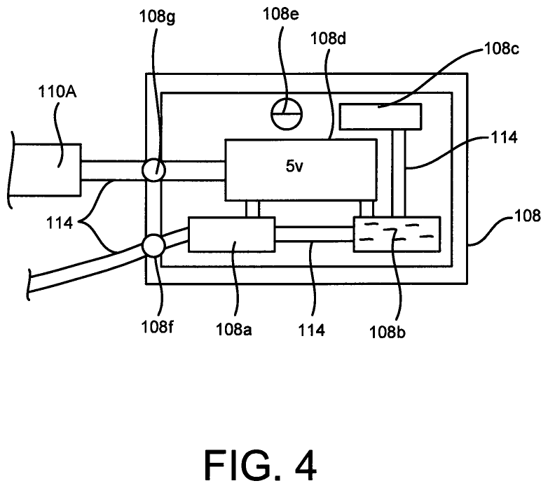

Referring to FIG. 4, the electronic unit (108) of the smart triggering device (104) is described herein. The electronic unit (108) is connected with the biometric recognition surface (106) to process the biometric information inputted by the user. The electronic unit (108) is connected with the biometric recognition surface (106) through a high gauge wire (114) at the input unit (108f) included in the electronic unit (108). The input/ output unit (108f/108g) is a general-purpose input/output (GPIO). The GPIO is a digital data pin on a circuit (either an integrated circuit or electronic circuit board). A user may change the GPIO's function at run time and manipulate the pins to operate as inputs or outputs.

In primary embodiment of the present invention, the electronic unit (108) includes a data memory chip (108A) for permanently storing the records of a user or multiple users. The records of user include the biometric information of the user or firing details including firing time, date etc. The electronic unit further includes the biometric recognition chip (108B), which compares the inputted biometric input with the stored records of user. The biometric recognition chip (108B) thus verifies the authorization of the user to use the firearm. In one alternative embodiment, the biometric recognition chip (108B) is a fingerprint recognition chip which recognizes a fingerprint of the shooting finger or the index finger. The electronic unit (108) further provides a signal to the electromagnetic stopper (110) of the smart trigger device (104) through the high gauge wire (114) from the output unit (108g) to allow access to the authorized user to use the firearm (100).

The electronic unit (108) further includes plurality of batteries one is the USB battery (108C) and the other is the Li-battery (108D). The USB battery (108C) is connected to each of the biometric recognition chip (108B) and the data memory chip (108A) of the electronic unit (108) via high gauge wires (114). The Li-battery (108D) provides voltage to the smart triggering device (104). Any lithium battery that provides power to the smart triggering device or any conventional battery is within the scope of the invention. The Li-battery (108D) is 5 Volt Lithium battery is used for providing power to the smart triggering device (104). The USB battery (108C) is charged through the port (108e). If the USB-battery/Li-battery (108C/108D) is inoperative, for any reason, the firearm (100) will be in normal mode with the user having an option to choose a manual safety mode or ready to fire position.

The USB port (108D) included in the electronic unit (108) is connected to the biometric recognition chip (108B) and to the battery (108C). The USB port (108D) may be used for charging the battery (108C) whenever necessary. The USB port (108D) is also used to retract records of the user including biometric information, fire arm operational details such as but not limited to firing time, date etc. This data indicates the use of weapon by its authorized user and this data can be very beneficial in case of theft of weapon to track the weapon back to its owner.

The electronic unit (108) is embedded in a handgrip of the firearm. The size and location of the chips (108A), (108B), the battery (108C), and the USB ports (108D) would vary for different firearms depending upon the size of the firearms.

In one embodiment, the electronic unit (108) may be a microprocessor or digital signal processor. The electronic unit (108) compares inputted biometric information to the information stored as the profile of the lawful owner or authorized user. The microprocessor simultaneously reads the signals from all of the sensors and continuously searches for the dynamic pattern corresponding to the valid “profile” of the lawful owner. The authorization of the user is verified during predetermined time interval i.e.

microseconds for allowing the authorized user to access the firearm.

In an alternative embodiment, the electronic unit (108) includes a circuitry that executes pre-programmed instructions with received biometric inputs as parameters, supervises the validation of user biometric input against the data stored of authorized biometric information, and if authorized, commands the trigger to unlock for accessing the firearm. When the biometric input is provided to the biometric recognition surface, the circuitry wakes up and identifies the user attempting to access the trigger of the firearm.

Upon recognition and verification of the user, the open circuitry of the electronic unit (108) is in closed loop, thereby providing activation signal to the electromagnetic stopper (110) to retrieve, for unlocking the trigger (102) of the firearm (100).

When the user removes biometric input from the trigger (102) or in a scenario where the firearm is dropped, then the electronic unit's (108) circuit would return back to an open circuit position, thereby providing deactivation signals to the electromagnetic stopper (110) to lock the trigger (102) of the firearm (100).

The trigger (102) is locked prior to authentication through the biometric recognition chip (108B) and is in unlocked stage only for the time till the user's biometric input is over the biometric recognition surface (106), if the user of the firearm (100) removes his/her biometric input from the biometric recognition surface (106), within fraction of seconds, the trigger (102) of the firearm (100) comes to locked state automatically, this functionality provides additional security as the firing of the firearm (100) is entirely dependent upon the trigger (102) activation. Every time before firing the firearm, the user has to authenticate himself/herself by providing the biometric input for fraction of seconds.

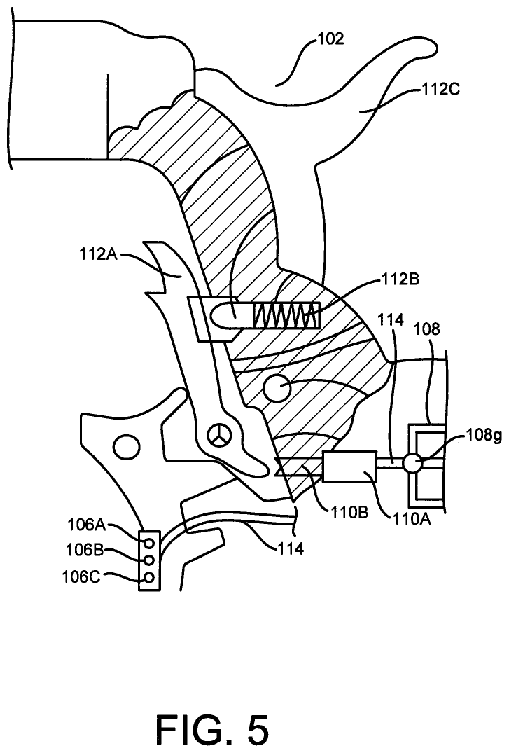

Referring to FIG. 5, an electromagnetic stopper (110) of the smart triggering device (104) is described herein. The electromagnetic stopper (110) is operatively connected with the electronic unit (108). The electromagnetic stopper (110) is housed within a positively protruding fine threaded housing, the electromagnetic stopper (110) includes a flat head shaft (110A) and a key stopper (110B) connected through high gauge linear spring. In one embodiment, the flat head shaft (110A) is spring loaded shaft that retrieves upon receiving signals through the electronic unit (108). The positively protruding fine threaded housing of the electromagnetic stopper (110) is engaged with the negative recessed threaded housing mounted on a handgrip of the firearm (100). The electromagnetic stopper (110) powered by the battery in the electronic unit (108) to unlock or lock the trigger (102) of the firearm (100).

In an alternative embodiment, the electromagnetic stopper (110) is a solenoid device which acts as a relay which gets only activated to energized state once it receives signals from the electronic unit (108). The electromagnetic stopper (110) further selectively engages with the hammer rod assembly (112) for unlocking trigger (102) of the firearm (100). The hammer rod assembly (112) includes a safety rod (112A), a firing hammer (112C) and a spring (112B) that connect the safety rod (112A) and the firing hammer (112C).

Upon receiving activation signal from the electronic unit (108), the flat head shaft (110A) retrieves, and electromechanically couples with the safety rod (112A) for unblocking the safety rod (112A). The safety rod (112A) further actuates the firing hammer (112C), the firing hammer (112C) is pulled back for unlock the trigger (102) of the firearm (100), thereby allowing the user for striking a bullet to be fired from the firearm (100).

Upon receiving deactivation signal from the electronic unit (108), in case when the biometric input is removed from the trigger (102) or the firearm is accidentally dropped, the flat head shaft (110A) of the electromagnetic stopper (110) retrieves back for blocking the safety rod (112A). The safety rod (112A) further pulls back the firing hammer (112C) for locking the trigger (102) of the firearm (100), thereby preventing the user to use the firearm (100).

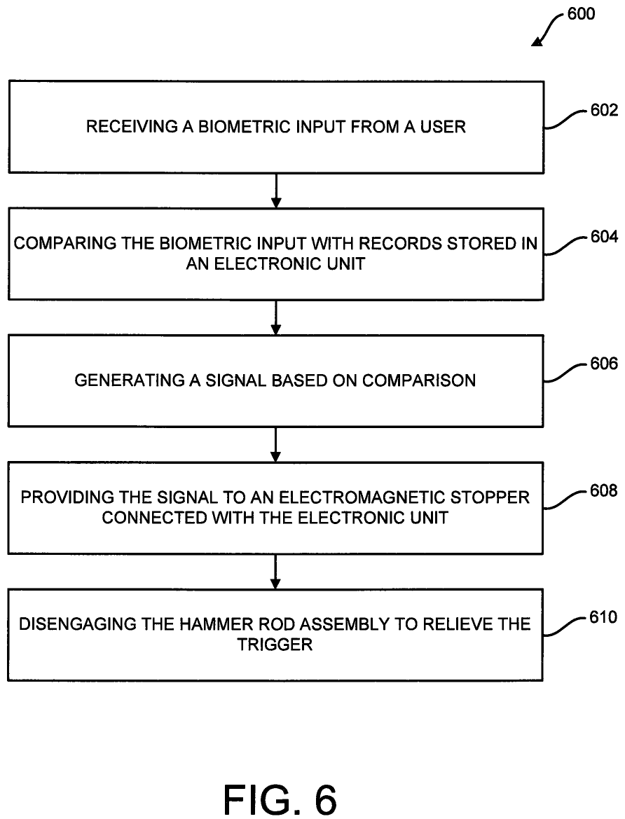

Referring to FIG. 6, the working operation for the smart trigger assembly (600). Firstly, receiving a biometric input from the user (602), the biometric input is received in the form of fingerprint via the fingerprint recognition surface. The fingerprint recognition surface is configured to receive fingerprint information directly via the sensors arranged in the trigger assembly. When the user places his/her hand over the fingerprint recognition surface a fingerprint is extracted by the sensors. A processor is configured to process the fingerprint in an encrypted signal.

The identified fingerprint is compared with the extracted information of the plurality of fingerprint records stored in the local memory of the electronic unit (604). When the match is identified, it deactivates the safety lock of the firearm by sending command via the gauge wire to the spring loaded electromagnetic stopper via a solenoid operated relay. A processor module configured to receive the user biometric and compare this biometric information with the information stored in the local memory of the electronic module for authentication purposes.

When the match is identified, the electronic unit generates a signal (606). The signal is transmitted to the electromagnetic stopper (608). The transmission of the signal is from the output unit of the electronic unit through the high gauge wire.

The method prevents unauthorized access to smart firearm trigger assembly by providing biometric input in the form of fingerprint wherein this input is received directly via fingerprint reorganization surface through various sensors.

The smart trigger assembly is also provided with data recovery output connection or port. This port can be any conventional port which is utilized for data transfer or special dedicated port for data transfer with other secure devices. This data indicates the use of weapon by its authorized user and this data can be very beneficial in case of theft of weapon to track the weapon back to its owner.

The smart trigger assembly includes electromagnetic assembly which can be solenoid operated relay which receives signal from the fingerprint recognition surface and depending on whether authorization step is complete activates the relay which in turn causes the weapon to be in firing configuration.

If the user is authentic the safety lock is disengaged (610) and the command signal via gauge wires activates a electromechanical relay, which in turn activates the hammer rod assembly of the firearm.

While, the various embodiments of the present invention have been described above, it should be understood that they have been presented by way of example only, and not of limitation. Likewise, the figure may depict an example architectural or other configuration for the invention, which is done to aid in understanding the features and functionality that can be included in the invention. The invention is not restricted to the illustrated example architectures or configurations, but the desired features can be implemented using a variety of alternative architecture and configurations.

Although, the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

1. A smart triggering device configured with a firearm, the smart triggering device comprising:
(a) a biometric recognition surface configured with a trigger of the firearm, wherein the biometric recognition surface receives a biometric input from a user;
(b) an electronic unit including:
(i) a data memory chip connected with the biometric recognition surface via a high gauge wire, wherein the data memory chip stores record of the user;
(ii) a biometric recognition chip connected with the data memory chip via the high gauge wire, wherein the biometric recognition chip is capable of matching the biometric input with the record of the user;
(iii) a battery connected with each of the data memory chip and the biometric recognition chip via the high gauge wire, wherein the battery provides voltage to the smart triggering device; and
(c) an electromagnetic stopper connected with the electronic unit and a hammer rod assembly, wherein the hammer rod assembly includes:
(i) a safety rod, the safety rod is capable of electromechanically coupling with the electromagnetic stopper; and
(ii) a firing hammer coupled with the safety rod via a spring, wherein the matching of the biometric input with the record of the user allows the electromagnetic stopper to engage with the hammer rod assembly for enabling the trigger to be pulled.

2. The smart triggering device according to claim 1, wherein the biometric input is a fingerprint of the user.

3. The smart triggering device according to claim 2, wherein the fingerprint is of an index finger or a shooting finger.

4. The smart triggering device according to claim 1 or claim 2, wherein the smart triggering device is capable of accepting additional biometric input from either of a retina, voice, facial, or an iris.

5. The smart triggering device according to claim 1, wherein the electronic unit further includes a USB port for retrieving data and charging the battery.

6. The smart triggering device according to claim 1, wherein the firearm is either of a pistol, a handgun, a shotgun or a revolver.

7. The smart triggering device according to claim 1, wherein the user is able to access the firearm till the biometric input is provided to the biometric recognition surface.

8. The battery according to claim 1 is a 5-volt DC flat lithium battery.

9. The data memory chip according to claim 1 is a data micro memory chip.

10. The record of user according to claim 1 is based on either of a time, a date and a firing time.

11. The smart triggering device according to claim 1, wherein matching of the biometric input with the record of the user unlocks the trigger of the firearm.

12. The smart triggering device according to claim 1, wherein the spring connected to the firing hammer allows the trigger to be pulled back for striking a bullet to be fired from the firearm.

13. The smart triggering device according to claim 1, wherein the electromagnetic stopper is housed within a positively protruding fine threaded housing, the electromagnetic stopper includes:
a flat head shaft;
a key stopper; and
a high gauge linear spring between the flat head shaft and the key stopper, wherein matching of the biometric input allows the flat head shaft to engage with the safety rod.

14. The electromagnetic stopper according to claim 13, wherein the flat head shaft is a spring loaded shaft.

15. The electromagnetic stopper according to claim 13, wherein the positive protruding fine threaded housing is housed in a negative recessed threaded housing on a hand grip of the firearm.

16. A method for preventing unauthorized access to a firearm, the method comprising:
(i) receiving a biometric input from a user, wherein the biometric input is received by a biometric recognition surface coupled with a trigger of the firearm;
(ii) comparing the biometric input with records stored in an electronic unit, wherein the electronic unit is connected with the biometric recognition surface;
(iii) generating a signal based on comparison, wherein the signal is generated by the electronic unit;
(iv) providing the signal to an electromagnetic stopper connected with the electronic unit, wherein the electromagnetic stopper retrieves and engages with a hammer rod assembly; and
(v) disengaging the hammer rod assembly to relieve the trigger.
